(19) United States
(12) Patent Application Publication
(10) Pub. No.: US 2023/0048436 A1
(43) Pub. Date: Feb. 16, 2023

(54) EARPHONE

(71) Applicant: Panasonic Intellectual Property Management Co., Ltd., Osaka (JP)

(72) Inventors: Tetsuji SADOSHIMA, Nara (JP); Shuji SAIKI, Nara (JP)

(21) Appl. No.: 17/794,167

(22) PCT Filed: Jun. 16, 2021
(86) PCT No.: PCT/JP2021/022837

§ 371 Date: Jul. 20, 2022

(30) Foreign Application Priority Data
Dec. 14, 2020 (JP) 2020-206846

(51) Int. Cl. H04R 1/10; H04R 1/28

(52) U.S. Cl. CPC H04R 1/1016; H04R 1/2823

(57) ABSTRACT

An earphone according to the present disclosure includes: a speaker unit that generates a sound wave; a case having one end and the other end opposite to the one end and housing the speaker unit; and a sound conduit connected to the one end side of the case and provided with a sound hole that emits the sound wave generated from the speaker unit, in which an internal space connected to the sound hole is provided between the speaker unit and the sound conduit in the case, and the case is provided with a plurality of vent holes that communicate the internal space with an external space that is outside the case.

### TECHNICAL FIELD

The present disclosure relates to an earphone.

### BACKGROUND ART

For example, Patent Literature 1 discloses a ventilation structure of an ear canal insertion type earphone. The earphone described in Patent Literature 1 includes a speaker unit, a sound conduit, and an ear tip, and the sound conduit is provided with a sound hole that emits a sound wave generated from the speaker unit and a vent hole that communicates the inside of the ear canal with an external space.

### PRIOR ART DOCUMENT

### Patent Document

Patent Literature 1: WO 2013/014852 A

### SUMMARY OF THE INVENTION

### Problems to be Solved by the Invention

However, the earphone described in Patent Literature 1 still has room for improvement in terms of improvement in sound quality.

Therefore, an object of the present disclosure is to solve the above problem and to provide an earphone capable of improving the sound quality.

### Means for Solving the Problems

In order to achieve the object, an earphone according to an aspect of the present disclosure includes:

a speaker unit that generates a sound wave;

a case having one end and the other end opposite to the one end and housing the speaker unit; and

a sound conduit connected to the one end side of the case and provided with a sound hole that emits the sound wave generated from the speaker unit,

in which an internal space connected to the sound hole is provided between the speaker unit and the sound conduit in the case, and

the case is provided with a plurality of vent holes that communicate the internal space with an external space that is outside the case.

### Effects of the Invention

The earphone according to the present disclosure can improve the sound quality.

### BRIEF DESCRIPTION OF THE DRAWINGS

FIG. 1 is a schematic perspective view of an example of an earphone according to a first embodiment of the present disclosure.

FIG. 2 is an exploded perspective view of the earphone of FIG. 1.

FIG. 3 is a plan view of the earphone of FIG. 1.

FIG. 4 is a cross-sectional view of the earphone of FIG. 1.

FIG. 5 is a schematic perspective view of an example of the earphone according to a second embodiment of the present disclosure.

FIG. 6 is an exploded perspective view of the earphone of FIG. 5.

FIG. 7 is a cross-sectional view of the earphone of FIG. 5.

FIG. 8 is a schematic diagram illustrating an example of an opening and closing operation mechanism of an opening and closing unit.

FIG. 9 is a schematic diagram illustrating an example of the opening and closing operation mechanism of the opening and closing unit.

### MODES FOR CARRYING OUT THE INVENTION

### (Knowledge Underlying the Present Disclosure)

An ear canal insertion type earphone used by inserting a receiver into an ear canal has a sealed type and an open type. In the sealed type, the ear canal is put into a sealed state by an ear tip attached to a tip of the receiver. In the open type, the inside of the ear canal and an external space are connected by a vent hole to be in an open state (a non-sealed state).

In the earphone described in Patent Literature 1, a sound conduit connected to a speaker unit is provided with a sound hole and the vent hole. The sound hole emits a sound wave from the speaker unit. The vent hole communicates the inside of the ear canal with the external space. Since the sound conduit is designed with an outer dimension that can be inserted into the ear canal, when the sound conduit is provided with the sound hole and the vent hole, an opening dimension of the sound hole is greatly limited. Therefore, in a configuration in which the vent hole and the sound hole are provided in the sound conduit as in the earphone described in Patent Literature 1, the sound hole is designed to be small, and there is a problem that sound quality is deteriorated.

Therefore, the present inventors have found a configuration of the earphone capable of improving the sound quality, and have reached the following invention.

An earphone of a first aspect of the present disclosure includes: a speaker unit that generates a sound wave; a case having one end and the other end opposite to the one end and housing the speaker unit; and a sound conduit connected to the one end side of the case and provided with a sound hole that emits the sound wave generated from the speaker unit, in which an internal space connected to the sound hole is provided between the speaker unit and the sound conduit in the case, and the case is provided with a plurality of vent holes that communicate the internal space with an external space that is outside the case.

In the earphone of a second aspect of the present disclosure, the plurality of vent holes may extend toward the other end side of the case, and a plurality of external openings of the plurality of vent holes open toward the external space may be provided on the other end side of the case.

In the earphone of a third aspect of the present disclosure, the case may include: a tubular case main body that houses the speaker unit therein and has a side wall provided with a plurality of internal openings that communicates the internal space with the plurality of vent holes; and a plurality of recessed wall portions arranged on a side wall portion provided with the plurality of internal openings in the side wall of the case main body, and defining the plurality of vent holes.

In the earphone of a fourth aspect of the present disclosure, the plurality of vent holes may be radially provided when viewed from the one end toward the other end of the case.

In the earphone of a fifth aspect of the present disclosure, the plurality of vent holes may be provided at equal intervals when viewed from the one end toward the other end of the case.

In the earphone of a sixth aspect of the present disclosure, a length of each of the plurality of vent holes may be larger than a height of the speaker unit.

The earphone of a seventh aspect of the present disclosure may further include a plurality of opening and closing units that are housed in the case on the other end side with respect to the speaker unit and open and close the plurality of vent holes.

In the earphone of an eighth aspect of the present disclosure, the plurality of opening and closing units may be provided with a plurality of opening and closing ports connected to the plurality of vent holes, and the plurality of opening and closing units may include a plurality of movable parts movable in the plurality of opening and closing ports.

In the earphone of a ninth aspect of the present disclosure, each of the plurality of vent holes may have a substantially constant opening cross-sectional area from the internal space toward the external space.

The earphone of a tenth aspect of the present disclosure may further include an ear tip attached to the sound conduit and provided with a through-hole connected to the sound hole.

Hereinafter, embodiments of the present disclosure will be described with reference to the accompanying drawings. In addition, in each of the drawings, each element is exaggerated in order to facilitate the description.

### First Embodiment

### [Overall Configuration]

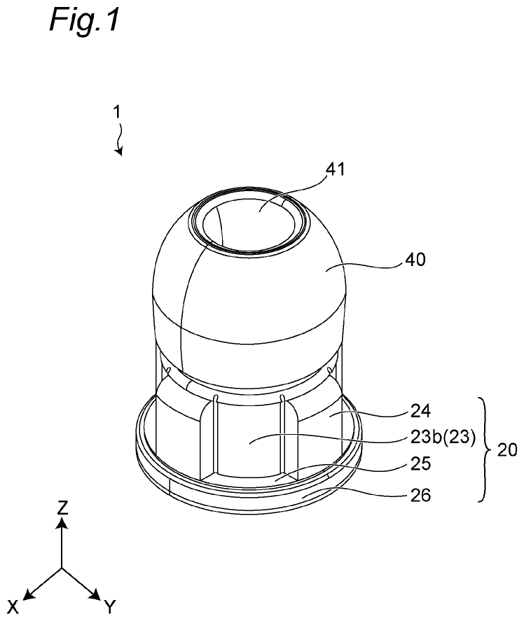

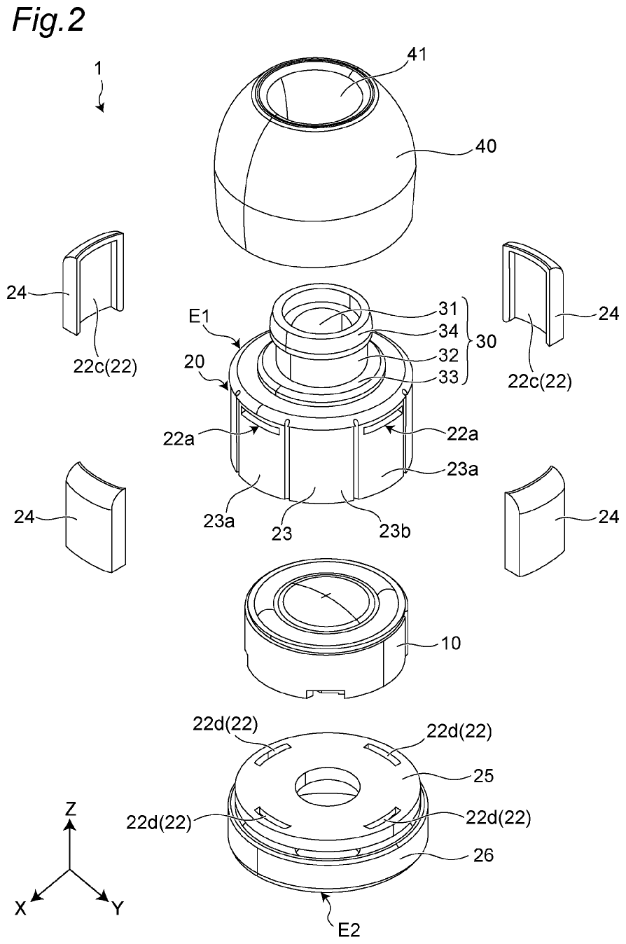

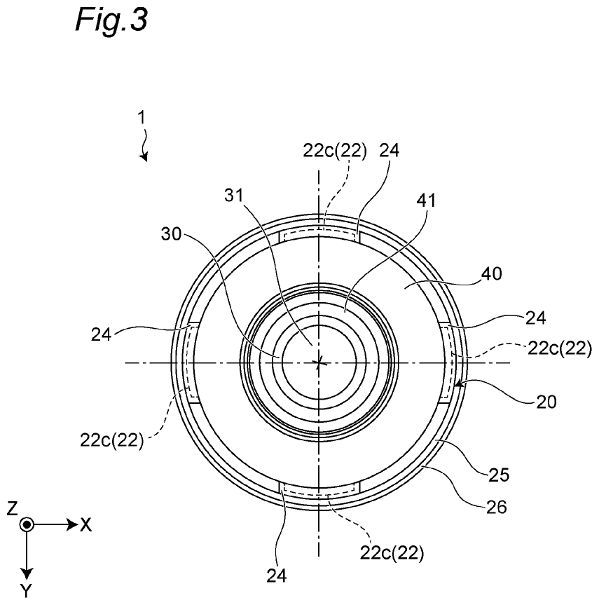

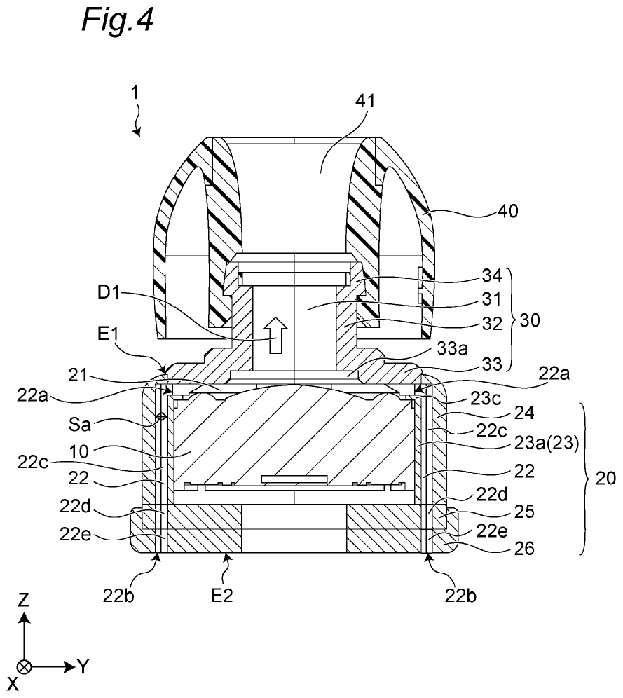

An example of the earphone according to a first embodiment of the present disclosure will be described. FIG. 1 is a schematic perspective view of an example of an earphone 1 according to the first embodiment of the present disclosure. FIG. 2 is an exploded perspective view of the earphone 1 of FIG. 1. FIG. 3 is a plan view of the earphone 1 of FIG. 1. FIG. 4 is a cross-sectional view of the earphone 1 of FIG. 1. Note that X, Y, and Z directions in the drawings respectively indicate a width direction, a depth direction, and a height direction of the earphone 1.

As illustrated in FIGS. 1 to 4, the earphone 1 includes a speaker unit 10, a case 20, a sound conduit 30, and an ear tip 40. The earphone 1 of the first embodiment is an open-type ear canal insertion type earphone.

### <Speaker Unit>

The speaker unit 10 generates the sound wave. Specifically, the speaker unit 10 generates the sound wave in a direction of an arrow D1 illustrated in FIG. 4 on the basis of a signal input from an external device (not illustrated) via a wired or wireless connection.

The speaker unit 10 converts an electric signal into vibration to generate the sound wave. The speaker unit 10 includes a magnetic circuit, a voice coil movable in a magnetic gap of the magnetic circuit, a diaphragm attached to the voice coil, and a frame that supports the magnetic circuit and the diaphragm. The speaker unit 10 generates a sound wave by supplying the electric signal to the voice coil and vibrating the diaphragm according to the electric signal. Note that a driving system and the like of the speaker unit 10 are not limited thereto.

For example, the speaker unit 10 has a disk shape.

### <Case>

The case 20 houses the speaker unit 10. The case 20 has a tubular shape having one end E1 and the other end E2 opposite to the one end E1. The sound conduit 30 is connected to the one end E1 of the case 20. The case 20 has a substantially cylindrical shape. For example, a material constituting the case 20 may be a resin such as ABS, or a metal such as aluminum, stainless steel, or magnesium alloy.

As illustrated in FIG. 4, in the case 20, an internal space 21 is provided between the speaker unit 10 and the sound conduit 30. The internal space 21 is connected to a sound hole 31 of the sound conduit 30 described later.

The case 20 is provided with a plurality of vent holes 22 that communicate the internal space 21 with an external space that is outside the case 20. Each of the plurality of vent holes 22 has an internal opening 22a connected to the internal space 21 and an external opening 22b connected to the external space.

The plurality of vent holes 22 extend toward the other end E2 side of the case 20. Specifically, the plurality of vent holes 22 extend straight from the one end E1 side toward the other end E2 of the case 20 in the height direction (Z direction) of the earphone 1. A plurality of the internal openings 22a are open toward the internal space 21 on the one end E1 side of the case 20. A plurality of the external openings 22b are open toward the external space on the other end E2 side of the case 20.

The plurality of vent holes 22 are radially provided when viewed from the one end E1 toward the other end E2 of the case 20. The plurality of vent holes 22 are provided on the same circumference when viewed from the one end E1 toward the other end E2 of the case 20. Specifically, the plurality of vent holes 22 are provided at equal intervals in a circumferential direction of the case 20 when viewed from the one end E1 toward the other end E2 of the case 20. In addition, the plurality of vent holes 22 are provided outside the speaker unit 10.

The length of each of the plurality of vent holes 22 is larger than the height of the speaker unit 10. The length of the vent hole 22 means a distance from the internal opening 22a to the external opening 22b. The height of the speaker unit 10 means a length in the height direction (Z direction) of the earphone 1.

In the first embodiment, the number of the plurality of vent holes 22 is four. Note that the number of the plurality of vent holes 22 is not limited to four. The number of the plurality of vent holes 22 may be two or more.

Each of the plurality of vent holes 22 has a substantially constant opening cross-sectional area Sa from the internal space 21 toward the external space. In the present specification, “substantially constant” includes an error within ±100. Preferably, “substantially constant” includes an error within ±5%.

The total opening area of the plurality of vent holes 22 is smaller than a cross-sectional area of the sound hole 31 of the sound conduit 30. The total opening area of the plurality of vent holes 22 is preferably 3.16 square millimeters or more. This makes it possible to produce a sound with a sense of openness. The total opening area of the plurality of vent holes 22 means the total opening area of the plurality of internal openings 22a. The cross-sectional area of the sound hole 31 means a cross-sectional area of a portion having the smallest cross-sectional area in the sound hole 31. In the first embodiment, since the vent hole 22 has a substantially constant opening cross-sectional area Sa from the internal space 21 toward the external space, the opening area of the vent hole 22 is equal to the opening cross-sectional area Sa. Note that when sizes of the internal opening 22a and the external opening 22b are different, an opening area of an opening having a smaller size is used as the opening area of the vent hole 22.

In the first embodiment, the case 20 includes a case main body (cylindrical body) 23, a plurality of recessed wall portions 24, a bottom plate 25, and a lid body 26.

The case main body 23 is a cylindrical member that houses the speaker unit 10 therein. Specifically, the case main body 23 has a cylindrical shape. The case main body 23 has a side wall provided with a plurality of internal openings 22a that communicates the internal space 21 with the plurality of vent holes 22.

The plurality of internal openings 22a are provided at equal intervals in the side wall of the case main body 23. Specifically, the side wall of the case main body 23 includes a plurality of first side wall portions 23a provided with the internal opening 22a, and a plurality of second side wall portions 23b not provided with the internal opening 22a. In the circumferential direction of the case main body 23, the first side wall portion 23a and the second side wall portion 23b are alternately arranged. A recessed wall portion 24 to be described later is disposed on the first side wall portion 23a. The second side wall portion 23b is a portion exposed to the external space.

The plurality of internal openings 22a penetrate the first side wall portions 23a of the case main body 23. Each of the plurality of internal openings 22a is formed in a rectangular shape having a longitudinal direction and a lateral direction. In the first embodiment, the longitudinal direction of the internal opening 22a is the circumferential direction of the case 20, and the lateral direction is the height direction (Z direction) of the case 20.

Further, an annular protruding portion 23c protruding to the inside of the case main body 23 is provided inside the case main body 23 on the one end E1 side. The protruding portion 23c forms a part of an inner wall defining the plurality of internal openings 22a. An inner diameter of the protruding portion 23c is smaller than an outer diameter of the speaker unit 10. Thus, it is possible to regulate the position of the speaker unit 10 in the height direction (Z direction) of the earphone 1 and to secure the internal space 21. In addition, the plurality of internal openings 22a can be smoothly connected to the internal space 21.

The plurality of recessed wall portions 24 are arranged on the plurality of first side wall portions 23a provided with the internal opening 22a in the side wall of the case main body 23, and define a plurality of first through-holes 22c. The first through-hole 22c is defined by the first side wall portion 23a of the case main body 23 and the recessed wall portion 24. Specifically, the first through-hole 22c is formed by a space defined by covering the first side wall portion 23a of the case main body 23 with the recessed wall portion 24. The first through-hole 22c forms a part of the vent hole 22.

The recessed wall portion 24 includes a plate-shaped member curved in a substantially arc shape, and an outer wall protruding from an outer edge of the plate-shaped member toward the side wall of the case main body 23. The other end E2 side of the case 20 in the plate-shaped member is an opening end, and the outer wall is not provided. The plate-shaped member is provided with the outer wall except for the other end E2 side of the case 20. The outer wall includes a first outer wall extending in a direction from the one end E1 toward the other end E2 of the case 20, and a second outer wall extending in the circumferential direction of the case main body 23 on the one end E1 side of the case 20.

As illustrated in FIG. 3, the plurality of recessed wall portions 24 are radially provided when viewed from the one end E1 toward the other end E2 of the case 20. Specifically, when viewed from the one end E1 toward the other end E2 of the case 20, they are provided at equal intervals in the circumferential direction of the case main body 23.

In the first embodiment, when viewed from the other end E2 side of the case 20, the plurality of first through-holes 22c have a round curved shape in the circumferential direction of the case 20.

The bottom plate 25 is disposed to be connected to an end portion of the case main body 23 on the other end E2 side of the case 20. The bottom plate 25 is a plate member having an annular shape in which a circular through-hole is provided at a center of the bottom plate 25. An outer diameter of the bottom plate 25 is larger than an outer diameter of the case main body 23. The bottom plate 25 is connected to the end portion of the case main body 23 and opening ends of the plurality of recessed wall portions 24. When viewed from the thickness direction (Z direction) of the bottom plate 25, a plurality of second through-holes 22d formed in a round curved shape are provided concentrically. The plurality of second through-holes 22d are provided corresponding to positions of the opening ends of the plurality of recessed wall portions 24, and form a part of the plurality of vent holes 22. Specifically, the plurality of second through-holes 22d face the opening ends of the plurality of recessed wall portions 24. That is, in the bottom plate 25, the plurality of second through-holes 22d are provided immediately below the opening ends of the plurality of recessed wall portions 24. Thus, the first through-hole 22c and the second through-hole 22d are connected to each other.

The lid body 26 is a lid attached to the bottom plate 25. The lid body 26 includes a plate member having an annular shape in which a circular through-hole is provided at a center of the lid body 26, and a side wall extending from an outer edge of the annular plate member along an outer periphery of the bottom plate 25. An outer diameter of the lid body 26 is larger than the outer diameter of the bottom plate 25. Similarly to the bottom plate 25, when viewed from the thickness direction (Z direction) of the lid body 26, a plurality of third through-holes 22e having a round curved shape are provided concentrically. The plurality of third through-holes 22e are provided corresponding to positions of the plurality of second through-holes 22d of the bottom plate 25, and form a part of the plurality of vent holes 22. Specifically, the plurality of third through-holes 22e face the plurality of second through-holes 22d of the bottom plate 25. That is, in the lid body 26, the plurality of third through-holes 22e are provided immediately below the plurality of second through-holes 22d of the bottom plate 25. Thus, the second through-hole 22d and the third through-hole 22e are connected to each other. Further, in the height direction (Z direction) of the case 20, an outer surface of the lid body 26 is the other end E2 of the case 20. In the outer surface of the lid body 26, that is the other end E2, the plurality of external openings 22b of the plurality of vent holes 22 opening toward the external space are provided.

An attachment structure of the lid body 26 to the bottom plate 25 is not particularly limited. For example, fitting, bonding, welding, screwing, and the like may be employed as the attachment structure.

For example, in a case where the earphone 1 is wired, a cable connected to the speaker unit 10 is arranged in the circular through-holes at the centers of the bottom plate 25 and the lid body 26.

In the first embodiment, the vent hole 22 is formed by the first through-hole 22c, the second through-hole 22d, and the third through-hole 22e connecting to each other. The first through-hole 22c is defined by the case main body 23 and the recessed wall portion 24. The second through-hole 22d is provided in the bottom plate 25. The third through-hole 22e is provided in the lid body 26. One end of the vent hole 22 formed by the first through-hole 22c, the second through-hole 22d, and the third through-hole 22e is the internal opening 22a, and the other end of the vent hole 22 is the external opening 22b.

Further, in the first embodiment, when viewed from the other end E2 side of the case 20, the plurality of vent holes 22 have a round curved shape in the circumferential direction of the case 20.

### <Sound Conduit>

The sound conduit 30 is a tubular member connected to the one end E1 of the case 20. Specifically, the sound conduit 30 is a cylindrical member connected to the case main body 23 of the case 20. The sound conduit 30 is provided with the sound hole 31 that emits the sound wave generated from the speaker unit 10. The sound hole 31 is a hole that is provided at a center of the sound conduit 30 when viewed from the height direction (Z direction) of the sound conduit 30 and penetrates the sound conduit 30 in the height direction (Z direction). The sound hole 31 communicates the outside of the earphone 1 with the internal space 21 of the case 20. Further, when the user wears the earphone 1 on an outer ear, the sound hole 31 communicates the inside of the ear canal with the internal space 21 of the case 20. For example, a material constituting the sound conduit 30 may be a resin such as ABS, or a metal such as aluminum, stainless steel, or magnesium alloy.

In the first embodiment, the sound conduit 30 includes a sound conduit main body (tubular member) 32, a flange 33, and an attachment portion 34.

The sound conduit main body 32 is a cylindrical member having a cylindrical shape having one end and the other end. An outer diameter of the sound conduit main body 32 is smaller than an outer diameter of the case 20. The one end of the sound conduit main body 32 is an end portion on a side to which an ear tip 40 is attached, and the other end of the sound conduit main body 32 is an end portion on a side connected to the case 20.

The flange 33 is an annular plate member protruding toward the outside of the sound conduit main body 32 at the other end of the sound conduit main body 32. The flange 33 is connected to the one end E1 of the case 20. In the first embodiment, when viewed from the other end side of the sound conduit main body 32, a recess 33a recessed from the other end toward the one end of the sound conduit main body 32 is provided at a center of the flange 33. When viewed from the other end side of the sound conduit main body 32, the recess 33a has a circular shape larger than the sound hole 31. A size of the internal space 21 can be adjusted by adjusting a depth of the recess 33a. Thus, the sound quality can be improved even without increasing a length of the sound conduit 30 in the height direction (Z direction).

The attachment portion 34 is an annular protruding member protruding toward the outside of the sound conduit main body 32 at the one end of the sound conduit main body 32. The ear tip 40 is attached to the attachment portion 34.

### <Ear Tip>

The ear tip 40 is a substantially cylindrical component attached to the sound conduit 30. The ear tip 40 is provided with a through-hole 41 connected to the sound hole 31. The ear tip 40 has a cylindrical shape having one end and the other end. A dome-shaped umbrella is formed at the one end of the ear tip 40. The other end of the ear tip 40 is attached to the attachment portion 34 of the sound conduit 30. For example, on the other end side of the ear tip 40, a recess is provided in an inner wall defining the through-hole 41. The ear tip 40 may be attached to the sound conduit 30 by the recess being fitted onto the attachment portion 34. A material constituting the ear tip 40 may be, for example, a rubber material such as silicone.

In a state where the earphone 1 is inserted into the ear canal, the dome-shaped umbrella of the ear tip 40 contacts a wall surface of the ear canal, to fix the earphone 1 in the ear canal.

When the earphone 1 according to the first embodiment configured as described above is worn in the ear canal, the earphone 1 can be used as an open type earphone.

### [Operation]

An operation of the earphone 1 will be described.

In a state where the earphone 1 is worn in the ear canal, the sound wave generated from the speaker unit 10 is emitted into the ear canal through the internal space 21 and the sound hole 31 and propagates to an eardrum. Since the case 20 is provided with the plurality of vent holes 22 communicating the internal space 21 with the external space, the inside of the ear canal is not in the sealed state but in the open state. When the inside of the ear canal is in the open state, there is no difference in pressure between the inside of the ear canal and the external space, so that it is possible to reduce a muffled sense and to produce the sound with the sense of openness.

The length of the plurality of vent holes 22 changes characteristics of an external sound entering the ear canal from the external space. In the earphone 1, by providing the plurality of vent holes 22 on the other end E2 side of the case 20, the length of the plurality of vent holes 22 is made larger than the height of the speaker unit 10. Therefore, the external sound enters the ear canal from the external space through the plurality of vent holes 22, the internal space 21, and the sound hole 31. As the external sound passes through the vent holes 22 in this manner, it is possible to reduce noise in a high-tone range of the external sound. By reducing the noise in the high-tone range due to the external sound, the sound generated from the speaker unit 10 is easy to listen to, and the sound quality is improved. In addition, since the external sound such as an announcement of a train is in a middle range, the external sound enters the ear canal without being cut by the plurality of vent holes 22. Therefore, the user using the earphone 1 can listen to the external sound other than the noise in the high-tone range while listening to the sound generated from the speaker unit 10.

The sound generated from the speaker unit 10 is emitted to the external space through the internal space 21 and the plurality of vent holes 22. Also in this case, the high-tone range of the sound emitted from the external space to the external space through the plurality of vent holes 22 is reduced. Therefore, it is possible to reduce the high-tone range of sounds leaking from the earphone 1 through the plurality of vent holes 22. Thus, sound leakage from the earphone 1 can be suppressed.

### [Effects]

The earphone 1 according to the first embodiment can obtain the following effects.

The earphone 1 includes the speaker unit 10, the case 20, and the sound conduit 30. The speaker unit 10 generates the sound wave. The case 20 has the one end E1 and the other end E2 opposite to the one end E1, and houses the speaker unit 10. The sound conduit 30 is connected to the one end E1 of the case 20. The sound conduit 30 is provided with the sound hole 31 that emits the sound wave generated from the speaker unit 10. In the case 20, the internal space 21 connected to the sound hole 31 is provided between the speaker unit 10 and the sound conduit 30. The case 20 is provided with the plurality of vent holes 22 that communicate the internal space 21 with the external space that is outside the case 20.

With such a configuration, the sound quality can be improved. Specifically, in the case 20, the internal space 21 is provided between the speaker unit 10 and the sound conduit 30, and the plurality of vent holes 22 that communicate the internal space 21 with the external space are provided in the case 20. In the earphone 1, since the vent hole 22 does not need to be provided in the sound conduit 30, the degree of freedom in designing the sound conduit 30 is increased. Thus, an opening dimension of the sound hole 31 of the sound conduit 30 can be sufficiently secured, so that sound quality can be improved.

In addition, the earphone 1 can suppress sound quality deterioration due to sound leakage in a low-tone range as compared with an earphone having a configuration in which the vent hole is provided in the sound conduit. In the earphone having the configuration in which the vent hole is provided in the sound conduit, the sound emitted from the speaker unit is emitted from the vent hole to the external space before being transmitted to the ear canal, an air pressure in a space formed by the eardrum and the ear canal is reduced, and the sound leakage in the low-tone range occurs, which causes the sound quality deterioration. In the earphone 1, since the vent hole 22 is not provided in the sound conduit 30, it is possible to suppress the sound emitted from the speaker unit 10 from being emitted from the vent hole 22 to the external space, and to suppress the sound quality deterioration due to the sound leakage in the low-tone range.

In addition, since the degree of freedom in designing the sound conduit 30 is increased, the sound conduit 30 does not need to have a special shape to which only a dedicated ear tip can be attached, so that it is also possible to have a configuration of the sound conduit 30 to which a ready-made ear tip can be attached.

In addition, since the degree of freedom in designing the sound conduit 30 is increased, downsizing of the earphone 1 can be achieved.

In addition, since the plurality of vent holes 22 communicate the internal space 21 with the external space, it is possible to produce the sound with the sense of openness while reducing the muffled sense.

The plurality of vent holes 22 extend toward the other end E2 side of the case 20, and the plurality of external openings 22b of the plurality of vent holes 22 open toward the external space are provided on the other end E2 side of the case 20. With such a configuration, since the plurality of external openings 22b of the plurality of vent holes 22 are provided on the other end E2 side of the case 20, the sound quality can be further improved. Specifically, it is possible to reduce the noise in the high-tone range of the external sound entering the ear canal from the external space through the plurality of vent holes 22. By reducing the noise in the high-tone range due to the external sound, the sound generated from the speaker unit 10 is easy to listen to, and the sound quality is improved. In addition, it is possible to reduce the high-tone range also in the sound generated from the speaker unit 10 and emitted to the external space through the internal space 21 and the plurality of vent holes 22. Thus, sound leakage from the earphone 1 can be suppressed.

The case 20 includes the case main body 23 and the plurality of recessed wall portions 24. The case main body 23 is a cylindrical body that houses the speaker unit 10 therein and has the side wall provided with the plurality of internal openings 22a that communicate the internal space 21 with the plurality of vent holes 22. The plurality of recessed wall portions 24 are arranged in the plurality of first side wall portions 23a provided with the internal opening 22a in the side wall of the case main body 23, and define the plurality of vent holes 22. With such a configuration, the plurality of vent holes 22 can be easily defined.

The plurality of vent holes 22 are radially provided when viewed from the one end E1 toward the other end E2 of the case 20. With such a configuration, the sound quality can be further improved. Specifically, deterioration of distortion characteristics of the speaker unit can be suppressed, and acoustic characteristics of broadband low distortion can be obtained.

The plurality of vent holes 22 are provided at equal intervals when viewed from the one end E1 toward the other end E2 of the case 20. With such a configuration, the sound quality can be further improved. In addition, aesthetic appearance of the earphone 1 is improved.

The length of each of the plurality of vent holes 22 is larger than a length of the speaker unit 10. With such a configuration, the high-tone range can be easily reduced in the plurality of vent holes 22, and the sound quality can be further improved.

Each of the plurality of vent holes 22 has a substantially constant opening cross-sectional area Sa from the internal space 21 toward the external space. With such a configuration, sound clarity is improved, and the high-tone range is more easily reduced. Thus, the sound quality can be further improved.

The earphone 1 further includes the ear tip 40 attached to the sound conduit 30 and provided with the through-hole 41 connected to the sound hole 31. With such a configuration, the wall surface of the ear canal can be sealed by the ear tip 40. This makes it easy to listen to the sound generated from the speaker unit 10.

Note that in the first embodiment, an example in which the earphone 1 includes the ear tip 40 has been described, but the present disclosure is not limited thereto. The ear tip 40 is not an essential component.

In the first embodiment, an example in which the plurality of external openings 22b of the plurality of vent holes 22 are provided at the other end E2 of the case 20 has been described, but the present disclosure is not limited thereto. For example, the plurality of external openings 22b may be provided in the side wall of the case 20.

Further, in the first embodiment, an example has been described in which when viewed from the other end E2 side of the case 20, the plurality of vent holes 22 have a round curved shape in the circumferential direction of the case 20, but the present disclosure is not limited thereto. For example, when viewed from the other end E2 side of the case 20, the plurality of vent holes 22 may have a substantially rectangular shape, a substantially elliptical shape, a substantially circular shape, a substantially semicircular shape, or the like.

In the first embodiment, an example has been described in which each of the plurality of vent holes 22 has a substantially constant opening cross-sectional area Sa from the internal space 21 toward the external space, but the present disclosure is not limited thereto. The opening cross-sectional area Sa of the plurality of vent holes 22 may vary. For example, the opening cross-sectional area Sa may increase or decrease from the internal space 21 toward the external space.

In the first embodiment, an example in which the length of each of the plurality of vent holes 22 is larger than the height of the speaker unit 10 has been described, but the present disclosure is not limited thereto. For example, the length of the vent hole 22 may be the same as the height of the speaker unit 10 or may be smaller than the height of the speaker unit 10.

In the first embodiment, an example has been described in which the plurality of vent holes 22 are radially provided when viewed from the one end E1 toward the other end E2 of the case 20, but the present disclosure is not limited thereto. For example, the plurality of vent holes 22 need not be radially provided when viewed from the one end E1 toward the other end E2 of the case 20.

In the first embodiment, an example has been described in which the plurality of vent holes 22 are provided at equal intervals when viewed from the one end E1 toward the other end E2 of the case 20, but the present disclosure is not limited thereto. For example, the plurality of vent holes 22 may be provided at different intervals when viewed from the one end E1 toward the other end E2 of the case 20.

### Second Embodiment

The earphone of a second embodiment according to the present disclosure will be described.

In the second embodiment, points different from the first embodiment will be mainly described. In the second embodiment, the same or equivalent components as those of the first embodiment will be described with the same reference numerals. Further, in the second embodiment, the description overlapping with the first embodiment will be omitted.

The second embodiment is different from the first embodiment in that a plurality of opening and closing units 50 are provided.

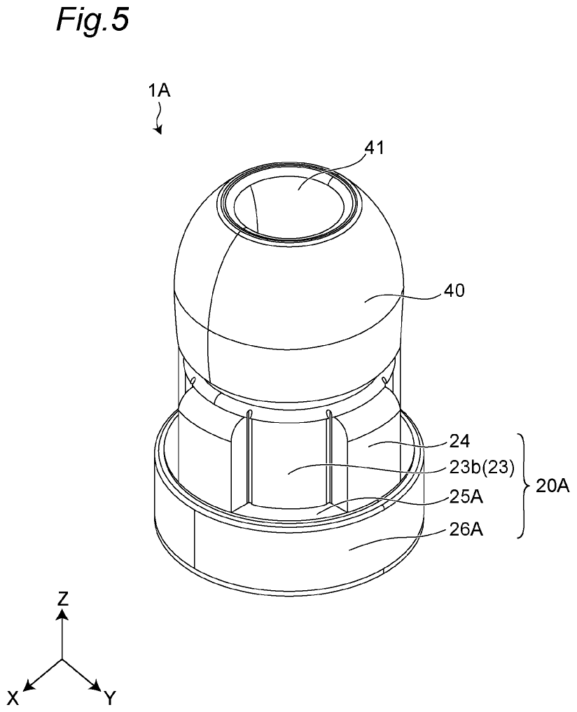

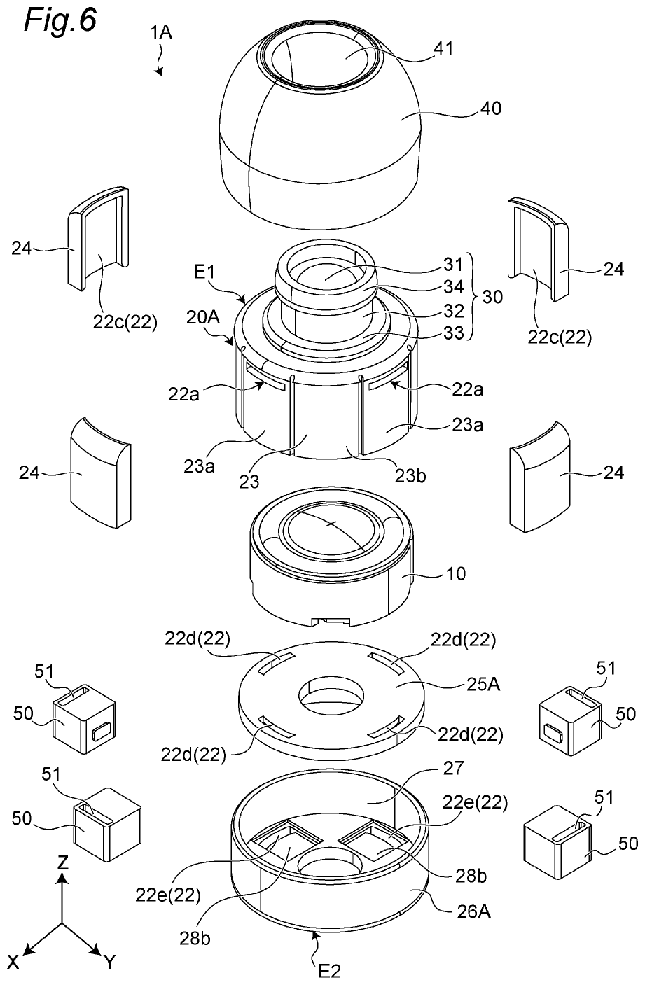

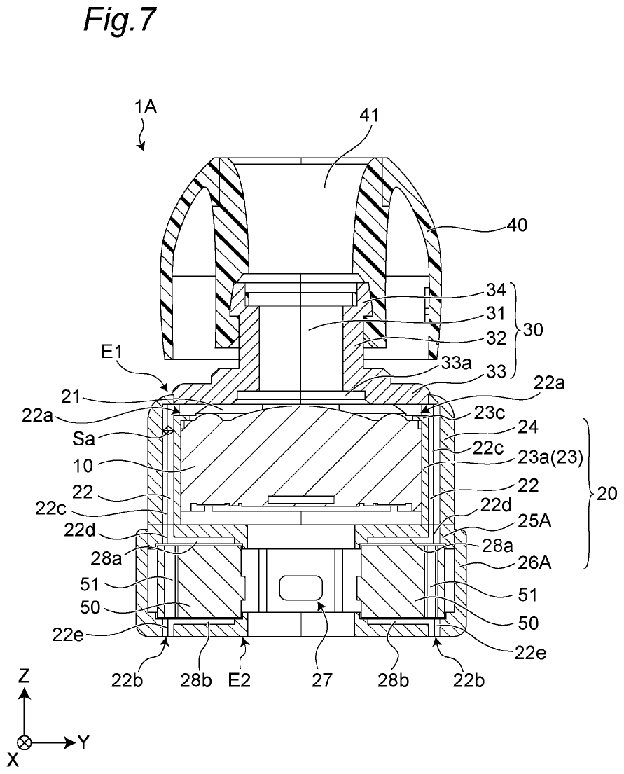

FIG. 5 is a schematic perspective view of an example of an earphone 1A according to the second embodiment of the present disclosure. FIG. 6 is an exploded perspective view of the earphone 1A of FIG. 5. FIG. 7 is a cross-sectional view of the earphone 1A of FIG. 5.

As illustrated in FIGS. 5 to 7, the earphone 1A includes the plurality of opening and closing units 50. By opening and closing the plurality of vent holes 22 by the plurality of opening and closing units 50, the earphone 1A can switch between the open state and the sealed state. In the second embodiment, the number of the plurality of opening and closing units 50 is equal to the number of the plurality of vent holes 22. That is, the number of the plurality of opening and closing units 50 is four.

In a case 20A of the earphone 1A, a bottom plate 25A and a lid body 26A are arranged away from each other in the height direction (Z direction) of the case 20, so that a housing space 27 for housing the plurality of opening and closing units 50 is provided between the bottom plate 25A and the lid body 26A. The plurality of opening and closing units 50 are arranged corresponding to the positions of the plurality of second through-holes 22d of the bottom plate 25A and the plurality of third through-holes 22e of the lid body 26A. Specifically, the plurality of opening and closing units 50 are arranged concentrically in the housing space 27 as viewed from the other end E2 side of the case 20. Further, the plurality of opening and closing units 50 are provided at equal intervals when viewed from the one end E1 toward the other end E2 of the case 20.

The bottom plate 25A is provided with a plurality of first recesses 28a in which the plurality of opening and closing units 50 are arranged. The plurality of first recesses 28a are provided on a surface of the bottom plate 25A on a side facing the lid body 26A. The plurality of first recesses 28a are provided concentrically when viewed from the other end E2 side of the case 20. Further, the plurality of first recesses 28a are provided at equal intervals when viewed from the other end E2 side of the case 20. The first recess 28a has a shape corresponding to an outer shape of the opening and closing unit 50. For example, the first recess 28a has a rectangular shape when viewed from the other end E2 side of the case 20. The second through-hole 22d is provided in a recessed surface of the first recess 28a.

The lid body 26A is provided with a plurality of second recesses 28b in which the plurality of opening and closing units 50 are arranged. The plurality of second recesses 28b are provided on a surface of the lid body 26A on a side facing the bottom plate 25A. The plurality of second recesses 28b are provided concentrically when viewed from the one end E1 side of the case 20. Further, the plurality of second recesses 28b are provided at equal intervals when viewed from the one end E1 side of the case 20. The second recess 28b has a shape corresponding to the outer shape of the opening and closing unit 50. For example, the second recess 28b has a rectangular shape when viewed from the one end E1 side of the case 20. The third through-hole 22e is provided in a recessed surface of the second recess 28b.

The plurality of opening and closing units 50 will be described in detail.

### <Plurality of Opening and Closing Units>

The plurality of opening and closing units 50 are housed in the case 20A on the other end E2 side with respect to the speaker unit 10, and open and close the plurality of vent holes 22. The plurality of opening and closing units 50 are arranged in the housing space 27 between the bottom plate 25A and the lid body 26A. Further, the plurality of opening and closing units 50 are sandwiched between the bottom plate 25A and the lid body 26A in a state of being arranged in the plurality of first recesses 28a of the bottom plate 25A and the plurality of second recesses 28b of the lid body 26A.

The plurality of opening and closing units 50 are provided with a plurality of opening and closing ports 51 connected to the plurality of vent holes 22. Specifically, one opening and closing unit 50 is provided with one opening and closing port 51 connected to one vent hole 22. The opening and closing port 51 is formed of a through-hole. When viewed from the other end E2 side of the case 20, the opening and closing port 51 has a round curved shape similarly to the second through-hole 22d and the third through-hole 22e. The opening and closing port 51 forms a part of the vent hole 22 and connects the second through-hole 22d and the third through-hole 22e.

The plurality of opening and closing units 50 are controlled by a control unit (not illustrated), and open and close the plurality of vent holes 22 by opening and closing the plurality of opening and closing ports 51. Specifically, the plurality of opening and closing units 50 open the plurality of vent holes 22 by opening the plurality of opening and closing ports 51, and bring the earphone 1A into the open state. The plurality of opening and closing units 50 close the plurality of vent holes 22 by closing the plurality of opening and closing ports 51, and bring the earphone 1A into the sealed state. In the second embodiment, opening and closing operations in the plurality of opening and closing units 50 are collectively performed by the control unit.

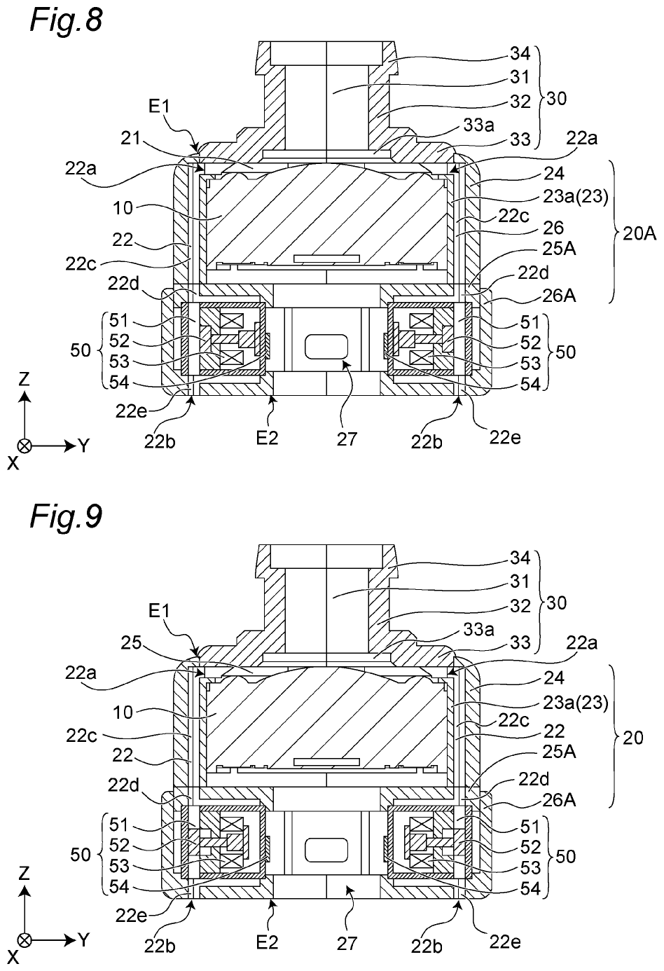

FIGS. 8 and 9 are schematic diagrams illustrating an example of an opening and closing operation mechanism of the opening and closing unit 50. FIG. 8 illustrates an example of a state in which the opening and closing unit 50 opens the opening and closing port 51. FIG. 9 illustrates an example of a state in which the opening and closing unit 50 closes the opening and closing port 51. As illustrated in FIGS. 8 and 9, the opening and closing unit 50 includes a movable part 52, an electromagnet 53, and an electrode 54.

The movable part 52 is a part movable in the opening and closing port 51. For example, the movable part 52 includes a plunger (movable iron core) and a rod provided at a tip of the plunger. The movable part 52 moves when current flows through the electromagnet 53.

When the current flows through the electromagnet 53, the movable part 52 moves into the opening and closing port 51 and closes the opening and closing port 51. When the current stops flowing through the electromagnet 53, the movable part 52 retracts from the opening and closing port 51 and opens the opening and closing port 51. For example, the electromagnet 53 is a coil. The electromagnet 53 is electrically connected to the electrode 54.

The electrode 54 is a conductor electrically connected to the electromagnet 53. The electrode 54 is electrically connected to the control unit via a wired or wireless connection. Voltage is applied to the electrode 54 by the control unit. Thus, the current flows from the electrode 54 to the electromagnet 53, and the movable part 52 can be moved.

### [Operation]

An operation of the earphone 1A will be described.

When the opening and closing port 51 is opened in each of the plurality of opening and closing units 50 in a state where the earphone 1A is worn in the ear canal, the earphone 1A functions as the open type. Specifically, in each of the plurality of opening and closing units 50, no voltage is applied to the electrode 54, and no current flows through the electromagnet 53. Therefore, the movable part 52 is disposed at a position retracted from the opening and closing port 51 (see FIG. 8). Thus, the plurality of vent holes 22 are connected to the external space, and the inside of the ear canal is in the open state.

When the opening and closing port 51 is closed in each of the plurality of opening and closing units 50 in the state where the earphone 1A is worn in the ear canal, the earphone 1A functions as the sealed type. Specifically, in each of the plurality of opening and closing units 50, the voltage is applied to the electrode 54, and the current flows through the electromagnet 53. Therefore, the movable part 52 moves into the opening and closing port 51 and closes the opening and closing port 51. Thus, the plurality of vent holes 22 are blocked from the external space, and the inside of the ear canal is in the sealed state.

As described above, in the earphone 1A, the opening and closing port 51 is opened and closed by movement of the movable part 52 in each of the plurality of opening and closing units 50. Thus, the earphone 1A can be used while being switched between the open state and the sealed state.

### [Effects]

The earphone 1A according to the second embodiment can obtain the following effects.

The earphone 1A includes the plurality of opening and closing units 50 that are housed in the case 20A on the other end E2 side with respect to the speaker unit 10 and open and close the plurality of vent holes 22. With such a configuration, it is possible to switch between the open state and the sealed state. In the open state, effects similar to those described in the first embodiment are obtained. Even in the sealed state, the sound leakage due to the vent holes 22 is suppressed, so that a sound pressure level in the low-tone range rises and high quality low-tone can be reproduced.

In addition, by housing the plurality of opening and closing units 50 on the other end E2 side of the case 20A, the design of the sound conduit 30 is not limited by the plurality of opening and closing units 50, so that the downsizing can be achieved while reducing the sound quality deterioration.

The plurality of opening and closing units 50 are provided with the plurality of opening and closing ports 51 connected to the plurality of vent holes 22, and the plurality of opening and closing units 50 include the plurality of movable parts 52 movable in the plurality of opening and closing ports 51. With such a configuration, it is possible to easily switch between the open state and the sealed state.

Note that in the second embodiment, an example in which the number of the plurality of opening and closing units 50 is four has been described, but the present disclosure is not limited thereto. The plurality of opening and closing units 50 only need to be able to open and close the plurality of vent holes 22, and the number of the plurality of opening and closing units 50 only needs to be two or more. For example, one opening and closing unit 50 may open and close two or more vent holes 22.

In the second embodiment, an example in which the opening and closing units 50 open and close the plurality of vent holes 22 by electrical control has been described, but the present disclosure is not limited thereto. For example, the opening and closing unit 50 may have a structure that mechanically opens and closes the plurality of vent holes 22 by a user's operation. Specifically, the opening and closing unit 50 may include a switch that manually moves the movable part 52.

In the second embodiment, an example has been described in which the opening and closing operations in the plurality of opening and closing units 50 are collectively performed by the control unit, but the present disclosure is not limited thereto. For example, the opening and closing operations in the plurality of opening and closing units 50 may be separately performed by the control unit. Further, the control unit may control the opening degree of each of the plurality of opening and closing units 50. The opening degree means the degree of opening of the opening and closing unit 50. For example, the control unit may adjust the opening degree of the opening and closing unit 50 in a range of 0% or more and 100% or less based on an input signal. For example, when it is desired to produce the sound with the sense of openness, the opening degrees of the plurality of opening and closing units 50 may be controlled to be large by the control unit. When it is desired to produce a sound focusing on a low tone, the opening degrees of the plurality of opening and closing units 50 may be controlled to be small by the control unit. Alternatively, the opening degrees of the plurality of opening and closing units 50 may be adjusted by the control unit in order to adjust a balance between the sense of openness and the low tone.

Further, the control unit may control the opening degrees of the plurality of opening and closing units 50 to be different from each other. That is, the control unit may independently control the opening degrees of the plurality of opening and closing units 50. Alternatively, the control unit may divide the plurality of opening and closing units 50 into a plurality of groups and control the opening degrees of the plurality of opening and closing units 50 for each group. For example, when four opening and closing units 50 are arranged symmetrically, two sets of two opening and closing units 50 facing each other may be respectively set as a first group and a second group. The control unit may control the opening degrees of the opening and closing units 50 in the same group to be the same. For example, the control unit may collectively control all the opening and closing units 50 included in the first group to be “opened”. Alternatively, the control unit may control such that the opening degrees of the opening and closing units 50 included in the first group are different from the opening degrees of the opening and closing units 50 included in the second group. For example, the control unit may control the opening and closing units 50 included in the first group to be “opened” and control the opening and closing units 50 included in the second group to be “closed”. Note that grouping of the plurality of opening and closing units 50 is not limited thereto, and may be performed by an arbitrary method.

Although the present disclosure has been fully described in connection with preferred embodiments with reference to the accompanying drawings, various variations and modifications will be apparent to those skilled in the art. It should be understood that such variations and modifications are included within the present disclosure as long as they do not depart from the scope of the present disclosure according to the appended claims.

### INDUSTRIAL APPLICABILITY

The earphone according to the present disclosure is applicable to the field of ear canal insertion type earphones.

### REFERENCE NUMERALS

1, 1A earphone
10 speaker unit
20, 20A case
21 internal space
22 vent hole
22a internal opening
22b external opening
22c first through-hole
22d second through-hole
22e third through-hole
23 case main body
23a first side wall portion
23b second side wall portion
23c protruding portion
24 recessed wall portion
25, 25A bottom plate
26, 26A lid body
27 housing space
28a first recess
28b second recess
30 sound conduit
31 sound hole
32 sound conduit main body
33 flange
34 attachment portion
40 ear tip
41 through-hole
50 opening and closing unit
51 opening and closing port
52 movable part
53 electromagnet
54 electrode
E1 one end
E2 other end
Sa opening cross-sectional area

1. An earphone comprising:
a speaker unit that generates a sound wave;
a case having one end and the other end opposite to the one end and housing the speaker unit; and
a sound conduit connected to the one end side of the case and provided with a sound hole that emits the sound wave generated from the speaker unit,
wherein an internal space connected to the sound hole is provided between the speaker unit and the sound conduit in the case, and
the case is provided with a plurality of vent holes that communicate the internal space with an external space that is outside the case.

2. The earphone according to claim 1, wherein
the plurality of vent holes extend toward the other end side of the case, and
a plurality of external openings of the plurality of vent holes open toward the external space are provided on the other end side of the case.

3. The earphone according to claim 1, wherein
the case includes:
a tubular case main body that houses the speaker unit therein and has a side wall provided with a plurality of internal openings that communicates the internal space with the plurality of vent holes; and
a plurality of recessed wall portions arranged on a side wall portion provided with the plurality of internal openings in the side wall of the case main body, and defining the plurality of vent holes.

4. The earphone according to claim 1, wherein the plurality of vent holes are radially provided when viewed from the one end toward the other end of the case.

5. The earphone according to claim 4, wherein the plurality of vent holes are provided at equal intervals when viewed from the one end toward the other end of the case.

6. The earphone according to claim 1, wherein a length of each of the plurality of vent holes is larger than a height of the speaker unit.

7. The earphone according to claim 1, further comprising a plurality of opening and closing units that are housed in the case on the other end side with respect to the speaker unit and open and close the plurality of vent holes.

8. The earphone according to claim 1, wherein
the plurality of opening and closing units are provided with a plurality of opening and closing ports connected to the plurality of vent holes, and
the plurality of opening and closing units include a plurality of movable parts movable in the plurality of opening and closing ports.

9. The earphone according to claim 1, wherein each of the plurality of vent holes has a substantially constant opening cross-sectional area from the internal space toward the external space.

10. The earphone according to claim 1, further comprising an ear tip attached to the sound conduit and provided with a through-hole connected to the sound hole.

11. The earphone according to claim 2, wherein
the case includes:
a tubular case main body that houses the speaker unit therein and has a side wall provided with a plurality of internal openings that communicates the internal space with the plurality of vent holes; and
a plurality of recessed wall portions arranged on a side wall portion provided with the plurality of internal openings in the side wall of the case main body, and defining the plurality of vent holes.

12. The earphone according to claim 2, wherein the plurality of vent holes are radially provided when viewed from the one end toward the other end of the case.

13. The earphone according to claim 3, wherein the plurality of vent holes are radially provided when viewed from the one end toward the other end of the case.

14. The earphone according to claim 2, wherein a length of each of the plurality of vent holes is larger than a height of the speaker unit.

15. The earphone according to claim 3, wherein a length of each of the plurality of vent holes is larger than a height of the speaker unit.

16. The earphone according to claim 2, further comprising a plurality of opening and closing units that are housed in the case on the other end side with respect to the speaker unit and open and close the plurality of vent holes.

17. The earphone according to claim 3, further comprising a plurality of opening and closing units that are housed in the case on the other end side with respect to the speaker unit and open and close the plurality of vent holes.

18. The earphone according to claim 2, wherein each of the plurality of vent holes has a substantially constant opening cross-sectional area from the internal space toward the external space.

19. The earphone according to claim 3, wherein each of the plurality of vent holes has a substantially constant opening cross-sectional area from the internal space toward the external space.

20. The earphone according to claim 2, further comprising an ear tip attached to the sound conduit and provided with a through-hole connected to the sound hole.
